(19) United States
(12) Patent Application Publication
(10) Pub. No.: US 2005/0168621 A1
(43) Pub. Date: Aug. 4, 2005

(54) Image capturing apparatus having a focus adjustment function

(75) Inventors: Kazumi Kageyama, Osaka (JP); Satoshi Yokota, Osaka (JP); Kazuyuki Hiroi, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 10/868,159

(22) Filed: Jun. 15, 2004

(30) Foreign Application Priority Data
Feb. 4, 2004 (JP) 2004-27553

(51) Int. Cl. H04N 5/232

(52) U.S. Cl. 348/349

(57) ABSTRACT

When an FFP mode is set, a quick-return mirror and a sub mirror are driven between an inclined position and a horizontal position according to whether the focus point is within the image capturing area of a phase difference AF module or not. When the focus point is set within the image capturing area of the phase difference AF module, focus adjustment is performed by a phase difference detection method using the phase difference AF module. When the focus point is set outside the image capturing area of the phase difference AF module, focus adjustment is performed by a contrast detection method with the entire image capturing area as the object area of the focus adjustment.

This application is based on the application No. 2004-27553 filed in Japan, the contents of which are hereby incorporated by reference.

### BACKGROUND OF THE INVENTION

1. Field of the Invention

The present invention relates to an image capturing apparatus having a focus adjustment function by a phase difference detection method and a focus adjustment function by a contrast detection method.

2. Description of the Related Art

For example, U.S. Pat. No. 6,453,124 discloses an image capturing apparatus having a quick-return mirror whose position can be changed between a steady position and a horizontal position. In the steady position, the quick-return mirror is inclined at an angle of 45 degrees to the optical axis of the taking lens system, and directs the subject image to the optical finder and the distance measurement sensor. In the horizontal position, the quick-return mirror is rotated upward from the steady position about a certain axis, and directs the subject image to the image sensor. Further, this laid-open patent application discloses a technology to change the position of the quick-return mirror between the above-mentioned two positions according to the presence or absence of the display of the live-view image and switch between the focus adjustment by the phase difference detection method and the focus adjustment by the contrast detection method according to the position of the quick-return mirror.

Japanese Laid-Open Patent Application No. 2003-125274 discloses a technology to provide an image capturing apparatus not having a quick-return mirror as described above, with a function to specify an arbitrary one of the subjects displayed on the image display portion as a position to be brought into focus (hereinafter, referred to as focus point) and a function to bring the specified focus point into focus.

In recent years, image capturing apparatuses having a quick-return mirror as described above and the focus adjustment functions by the phase difference detection method and by the contrast detection method have also been required to be provided with the function to specify the focus point. In that case, it is necessary to consider the following points:

When the focus adjustment by the phase difference detection method and the focus adjustment by the contrast detection method are compared with each other, according to the focus adjustment by the phase difference detection method, focus adjustment can be performed in a shorter time than according to the focus adjustment by the contrast detection method. However, according to the focus adjustment by the phase difference detection method, only a part of the shot image can be the region that can be brought into focus because of problems associated with the structure (for example, increase in the size of the distance measurement device and cost increase). On the other hand, according to the focus adjustment by the contrast detection method, substantially all the area of the shot image is the region that can be brought into focus and the accuracy of the focus adjustment is high. However, according to the focus adjustment by the contrast detection method, the time required for focus adjustment is longer than according to the phase difference detection method.

From this, when a mode to specify the focus point (hereinafter, referred to as focus point manually setting mode) is set in an image capturing apparatus having the focus point manually setting mode, according to the phase difference detection method, the region that can be brought into focus is limited. Therefore, to surely bring the specified focus point into focus, it is necessary to perform the focus adjustment by the contrast detection method at least when a position outside the region that can be brought into focus by the phase difference detection method is specified as the focus point.

When a position within the region that can be brought into focus by the phase difference detection method is specified as the focus point and when the focus point manually setting mode is not set, by performing focus adjustment by the phase difference detection method, focus adjustment can be quickly performed compared with the contrast detection method.

As described above, it is considered that the way of use of these focus adjustment functions should be changed according to parameters such as whether the focus point manually setting mode is set or not and the position of the focus point. When this idea is applied to the above-described image capturing apparatus where the focus adjustment function can be alternatively performed in accordance with the position of the quick-return mirror, it is necessary to control the operation of the quick-return mirror in accordance with the parameters.

### SUMMARY OF THE INVENTION

The present invention is made in view of the above-mentioned circumstances, and an object thereof is to realize a function to specify an arbitrary subject as the focus point in an image capturing apparatus provided with a quick-return mirror and the focus adjustment functions by the phase difference detection method and by the contrast detection method.

To attain the above-mentioned object, an image capturing apparatus according to the present invention comprises: an image sensor for photoelectrically converting a light image of a subject; an image capturing optical system including a focusing lens for forming a subject image on an image sensing surface of the image sensor; a first detector for detecting a focus condition of the focusing lens by a phase difference detection method; a second detector for detecting a focus condition of the focusing lens based on an image obtained by the image sensor; a mode selector for switching between a first mode in which input to specify a position within an image capturing area of the image sensor as a focus point is possible and a second mode in which focus adjustment is performed with the focus point automatically selected; an operation member for performing input to specify the focus point in the first mode; and a focus controller for performing a first control to perform focusing of the focusing lens based on a result of the detection by the first detector and a second control to perform focusing of the focusing lens based on a result of the detection by the second detector, and for switching between the first control and the second control when the first mode is set.

To attain the above-mentioned object, another image capturing apparatus according to the present invention comprises: an image sensor for photoelectrically converting a light image of a subject; an image capturing optical system including a focusing lens for forming a subject image on an image sensing surface of the image sensor; a mode selector for switching between a first mode in which input to specify a position within an image capturing area of the image sensor as a focus point is possible and a second mode in which focus adjustment is performed with the focus point automatically selected; an operation member for performing input to specify the focus point in the first mode; an optical path changing optical system whose position is changeable between a first position, in an optical path from the image capturing optical system to the image sensor, and a second position, withdraw from the optical path; a driver for driving the optical path changing optical system in the second position when the first mode is set; a first detector for detecting a focus condition of the focusing lens based on an image obtained by the image sensor in a predetermined area corresponding to a position specified as the focus point by the operation member when the first mode is set; and a focus controller for causing the focusing lens to perform focusing based on a result of the detection by the first detector.

To attain the above-mentioned object, further another image capturing apparatus according to the present invention comprises: an image sensor for photoelectrically converting a light image of a subject; an image capturing optical system including a focusing lens for forming a subject image on an image sensing surface of the image sensor; a focus controller for causing the focusing lens to perform focusing; an optical path changing optical system whose position is changeable between a first position, in an optical path from the image capturing optical system to the image sensor, and a second position, withdraw from the optical path; a display for displaying an image obtained by the image sensor; a driver for driving the optical path changing optical system between the first position and the second position; a first mode selector for switching between a first mode in which input to specify a position in an image capturing area of the image sensor as a focus point is possible and a second mode in which focus adjustment is performed with the focus point automatically selected; an operation member for performing input to specify the focus point in the first mode; and a second mode selector for selecting a display mode to display the image of the subject on the display, wherein when the display mode is set by the second mode selector, the first mode selector sets the first mode.

According to the present invention, when the first mode is set, focusing can be performed by an appropriate focus adjustment method according to the condition associated with the mode.

Further, according to the present invention, focusing can be performed by an appropriate focus adjustment method according to the position specified as the focus point.

### BRIEF DESCRIPTION OF THE DRAWINGS

In the following description, like parts are designated by like reference numbers throughout the several drawings.

FIG. 1 is a view showing the internal structure of an image capturing apparatus according to the present invention;

FIG. 2 is a front view showing the structure of the image capturing apparatus according to the present invention;

FIG. 3 is a rear view showing the structure of the image capturing apparatus according to the present invention;

FIG. 4 shows an example of the display screen of an optical finder;

FIG. 5 is a view showing the structure of a phase difference AF module;

FIGS. 6(a) to 6(c) are views of assistance in explaining a method of detecting the focus position by the phase difference detection method;

FIG. 7 is a view showing a condition where the positions of a quick-return mirror and a sub mirror are changed from those shown in FIG. 1;

FIGS. 8(a) to 8(c) are views showing the relationship between the operation of a jog dial and the display condition of the display screen of the optical finder when an FFP mode is set;

FIG. 9 is a view showing the relationship between the operation of the jog dial and a cursor displayed on an LCD when the FFP mode is set;

FIG. 10 is a view showing the block structure of the image capturing apparatus;

FIG. 11 is an explanatory view of the focus adjustment by the contrast detection method;

FIG. 12 is a flowchart showing a series of processings of the image capturing apparatus according to the present invention;

FIG. 13 is a flowchart showing a series of processings of the image capturing apparatus according to the present invention;

FIG. 14 is a flowchart showing a series of processings of the image capturing apparatus according to the present invention;

FIGS. 15(a) and 15(b) are views of assistance in explaining a modification of the present invention; and

FIG. 16 is a flowchart showing a series of processings in an image capturing apparatus according to another modification.

### DETAILED DESCRIPTION OF THE PREFERRED EMBODIMENT

An embodiment of an image capturing apparatus according to the present invention will be described with reference to the drawings.

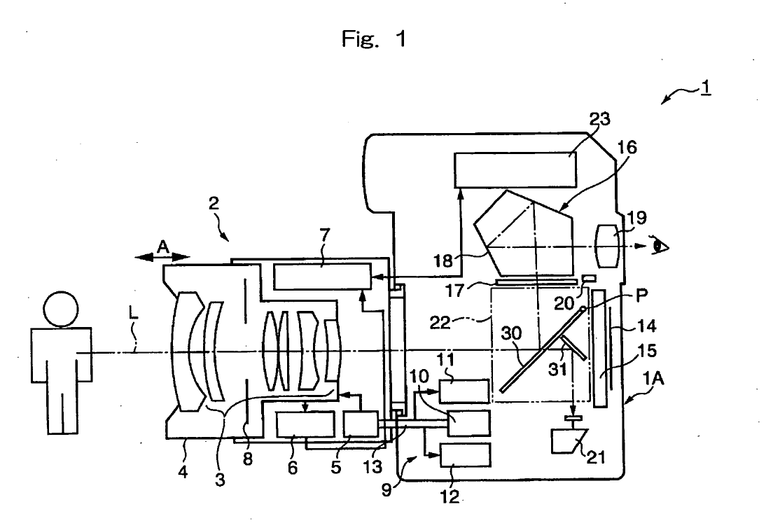

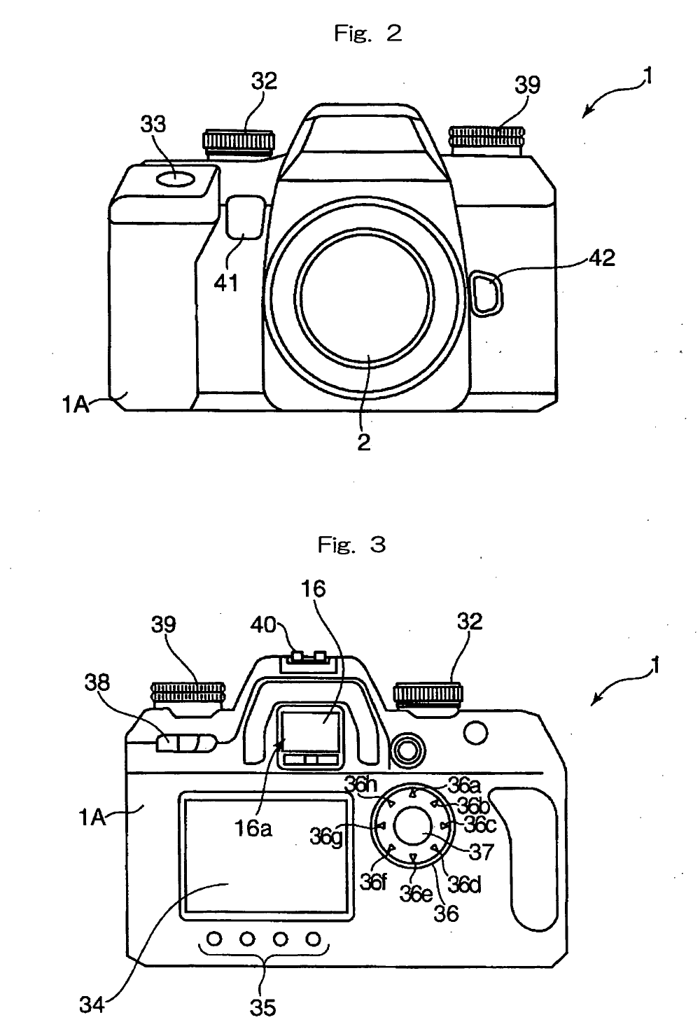

FIG. 1 is a view showing the internal structure of the image capturing apparatus. FIG. 2 is a front view showing the structure of the image capturing apparatus. FIG. 3 is a rear view showing the structure of the image capturing apparatus. In FIGS. 1 to 3, the same members and the like are denoted by the same reference numerals.

As shown in FIG. 1, the image capturing apparatus 1 according to the present embodiment is a single-lens reflex camera where a lens unit 2 is interchangeably attached to a box-shaped body 1A. The lens unit 2 is provided with an image capturing optical system 3, a lens barrel 4, a lens driving mechanism 5, a distance encoder 6 and a lens controller 7.

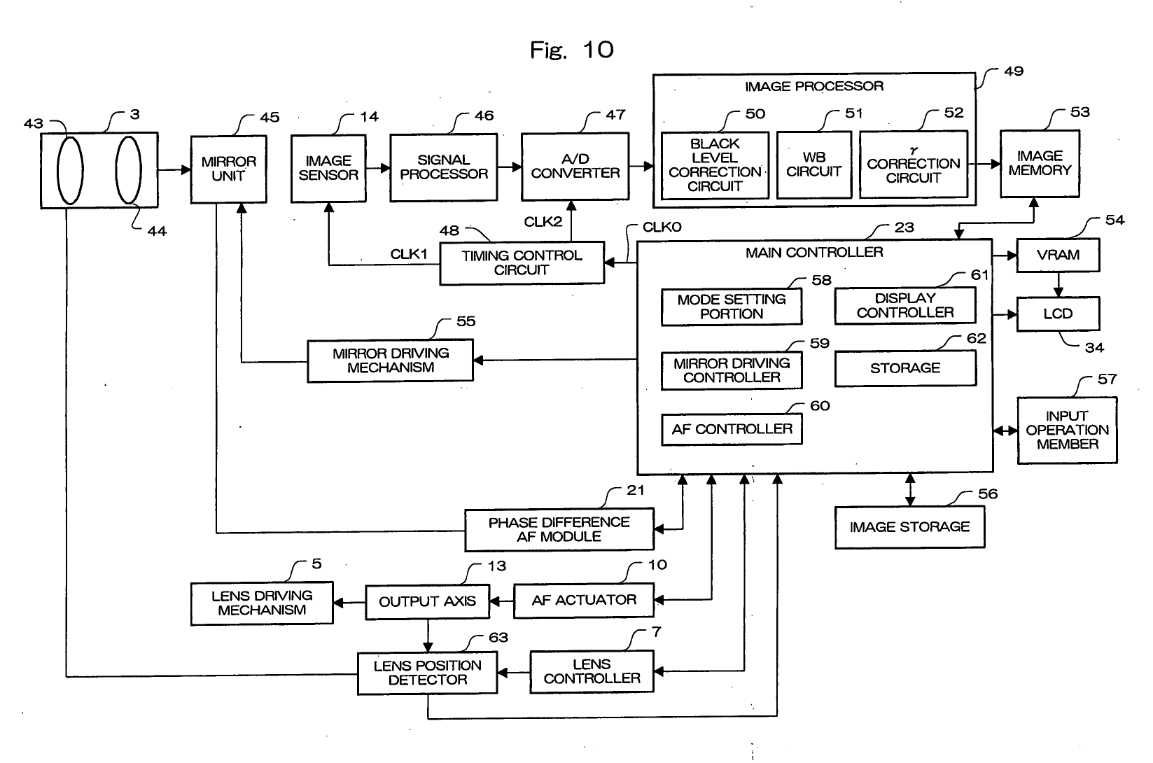

The image capturing optical system 3 is provided with a zoom lens system 43 for changing the shooting magnification (focal length) (see FIG. 10), a focusing lens system 44 for adjusting the focus position (see FIG. 10) and a diaphragm 8 for adjusting the quantity of light incident on an image sensor 14 or the like, described later, provided in the body 1A. The zoom lens system 43, the focusing lens system 44 and the diaphragm 8 are held in the direction of the optical axis L in the lens barrel 4. The image capturing optical system 3 captures a light image of the subject and forms the light image on the image sensor 14 or the like. The change of the shooting magnification (focal length) and the focus adjustment are performed by the image capturing optical system 3 or the lens barrel 4 being driven in the direction of the optical axis L by an AF actuator 10, described later, provided in the body 1A.

The lens driving mechanism 5 which comprises, for example, a helicoid and a non-illustrated gear rotating the helicoid receives the driving force from the AF actuator 10 and integrally moves the image capturing optical system 3 and the lens barrel 4 in the direction of the arrow A parallel to the optical axis L. The movement direction and the movement amount of the image capturing optical system 3 and the lens barrel 4 are determined by the rotation direction and the number of revolutions of the AF actuator 10, respectively.

The distance encoder 6 is provided with an encoding plate where a plurality of code patterns is formed at a predetermined pitch in the direction of the optical axis L within the movement range of the image capturing system 3, and an encoder brush that moves integrally with the lens barrel 4 while slidingly contacting the encoding plate. The distance encoder 6 is provided for detecting the movement amount of the lens barrel 4 (the movement amount of the image capturing optical system 3 at the time of focus adjustment).

The lens controller 7 stores the focal length and the aperture value (the open aperture value, the open aperture value for AF, or the minimum aperture value) of the lens, receives the detection signal of the distance encoder 6, and outputs the detection signal to a main controller 23 provided in the body 1A. The detection signal of the distance encoder 6 is used for calculating the in-focus position of the image capturing optical system 3.

The body 1A is provided with an AF driving unit 9, the image sensor 14, a shutter unit 15, an optical finder 16, a phase difference AF module 21, a mirror box 22 and the main controller 23.

The AF driving unit 9 is provided with an AF actuator 10, a distance encoder 11, an AF encoder 12 and an output axis 13. The AF actuator 10 includes a DC motor, a stepping motor, a motor such as an ultrasonic motor, for generating a driving source and a non-illustrated reduction system for reducing the number of revolutions of the motor. Although not described in detail, the distance encoder 11 and the AF encoder 12 detect the rotation amount transmitted from the AF actuator 10 to the output axis 13, and the detected rotation amount is used for calculating the position of the image capturing optical system 3. The output axis 13 transmits the driving force outputted from the AF actuator 10, to the lens driving mechanism 5 in the lens unit 2.

The image sensor 14 is disposed substantially parallel to the rear surface of the body 1A in a region on the side of the rear surface. The image sensor 14 is, for example, a CCD (charge-coupled device) color area sensor of a Bayer arrangement where a plurality of photoelectric conversion elements each comprising a photodiode or the like is two-dimensionally arranged in a matrix and color filters of, for example, R (red), G (green) and B (blue) having different spectral characteristics are disposed at a ratio of 1:2:1 on the light receiving surfaces of the photoelectric conversion elements. The image sensor 14 converts the light image of the subject formed by the image capturing optical system 3 into analog electric signals (image signals) of color components R (red), G (green) and B (blue), and outputs them as image signals of R, G and B. The image sensor 14 may comprise a solid-state image sensor such as a CMOS (complementary metal-oxide semiconductor).

The shutter unit 15 has a focal-plane shutter (hereinafter, referred to merely as shutter), and is disposed between the rear surface of the mirror box 22 and the image sensor 14.

The optical finder 16 is disposed above the mirror box 22 disposed substantially in the center of the body 1A, and comprises a focusing screen 17, a prism 18, an eyepiece 19 and a finder display device 20. The prism 18 reverses the image on the focusing screen 17 left to right and directs it to the user's eye through the eyepiece 19 so that the subject image can be visually recognized. The finder display device 20 displays the shutter speed, the aperture value, the exposure correction value and the like in a lower part of the display screen formed within a finder frame 16a. (see FIG. 3).

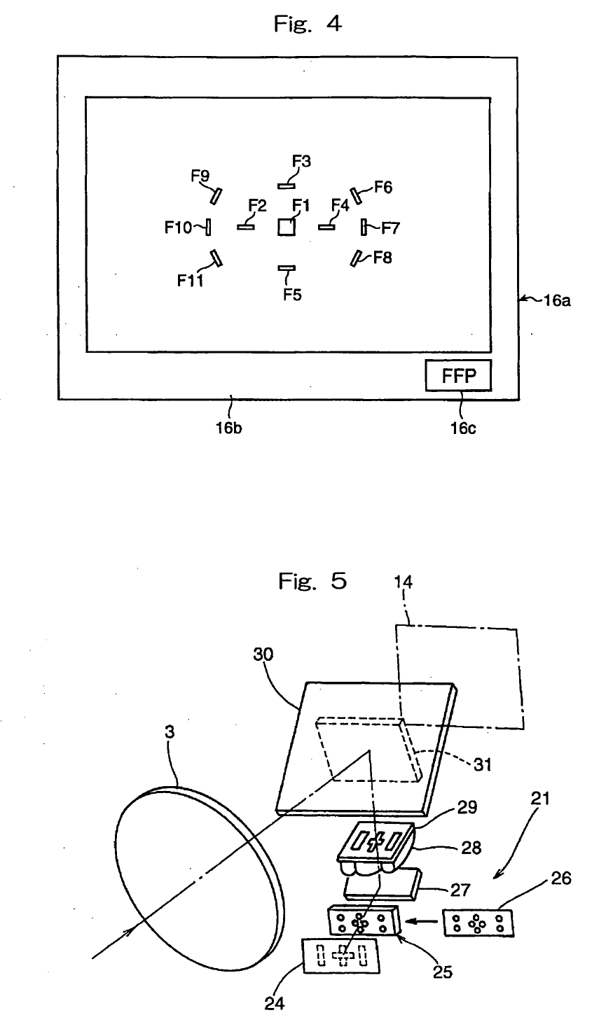

The image capturing apparatus 1 has a flex focus point mode (hereinafter, referred to as FFP mode) in which an arbitrary subject in the shooting area can be specified as the object to be brought into focus. When the FFP mode is set, the finder display device 20 provides a display indicative of that in an appropriate position within the finder frame 16a (a display portion 16c in FIG. 4).

The phase difference AF module 21 is disposed below the mirror box 22, and detects the in-focus position by the phase difference detection method.

FIG. 5 is a view showing the structure of the phase difference AF module 21.

As shown in FIG. 5, the phase difference AF module 21 comprises a sensor 24, a separator lens 25, a diaphragm mask 26, a mirror 27, a condenser lens 28 and a field mask 29. The sensor 24 has a plurality of sensor arrays each comprising a plurality of pixels. The separator lens 25 is disposed in front of the sensor 24 (on the side closer to the image capturing optical system 3), and has a plurality of pairs of lens elements each corresponding to a sensor array. The diaphragm mask 26 is disposed in front of the separator lens 25, and has openings corresponding to the lens elements of the separator lens 25. The mirror 27 bends the optical path in a predetermined direction. The condenser lens 28 is disposed in front of the diaphragm mask 26 with the mirror 27 in between. The field mask 29 is disposed in front of the condenser lens 28, and has openings of shapes corresponding to the sensor arrays.

The sensor 24 is disposed in an image formation position equivalent to the image sensing surface of the image sensor 14 with respect to the image capturing optical system 3. The incident surface of the sensor 24 is situated at the focal plane of the separator lens 25. The separator lens 25 separates the incident luminous flux, and re-forms the subject image on each sensor array having a reference portion and a comparison portion. The diaphragm mask 26 has a plurality of circular or elliptical openings, and limits the luminous flux incident on the separator lens 25. The field mask 29 is disposed in the proximity of a position where the distance from the image capturing optical system 3 is relatively equal to the distance to the image sensor 14, and limits, of the incident luminous flux from the image capturing optical system 3, the luminous flux incident into the phase difference AF module 21. The openings of the field mask 29 correspond to the arrangement of the sensor arrays, and their shapes are, for example, such that the central opening is cross-shaped and the openings on both sides are rectangular.

In the phase difference AF module 21 having the above-described structure, when the image capturing optical system 3 is situated on the subject side of the in-focus position, the distance between a reference image and a comparison image obtained by being re-formed on the reference portion and the comparison portion is shorter than when in-focus state is obtained. When the image capturing optical system 3 is situated on the image sensor 14 side of the in-focus position, the distance between the reference and comparison images is longer than when in-focus state is obtained. From this, the focus position can be detected by detecting the distance between the reference image and the comparison image.

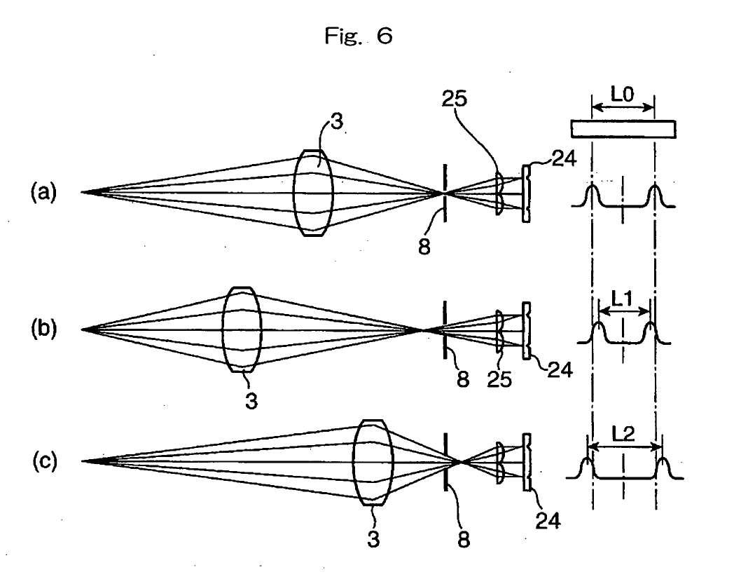

That is, when the image distance in in-focus state is L0 as shown in FIG. 6(a), as shown in FIG. 6(b), the image distance L1 on the sensor 24 when the image capturing optical system 3 is situated on the subject side of the in-focus position is shorter than the image distance L0 (L1<L0). On the other hand, as shown in FIG. 6(c), the image distance L2 on the sensor 24 when the image capturing optical system 3 is situated on the image sensor 14 side of the in-focus position is longer than the image distance L0 (L2>L0). With this, the in-focus position of the image capturing optical system 3 can be detected based on the detected image distance.

The phase difference AF module 21 is structured so that image capturing is performed by each sensor array in a plurality of positions in the central area of the image captured by the image sensor 14. As shown in FIG. 4, in the central area of a display frame 16b where the subject image is displayed, AF frames F1 to F11 are displayed so as to correspond to the sensor arrays. The phase difference AF module 21 obtains a reference image and a comparison image for each of the AF frames F1 to F11, and outputs in-focus data obtained from the distance between these images, to the main controller 23.

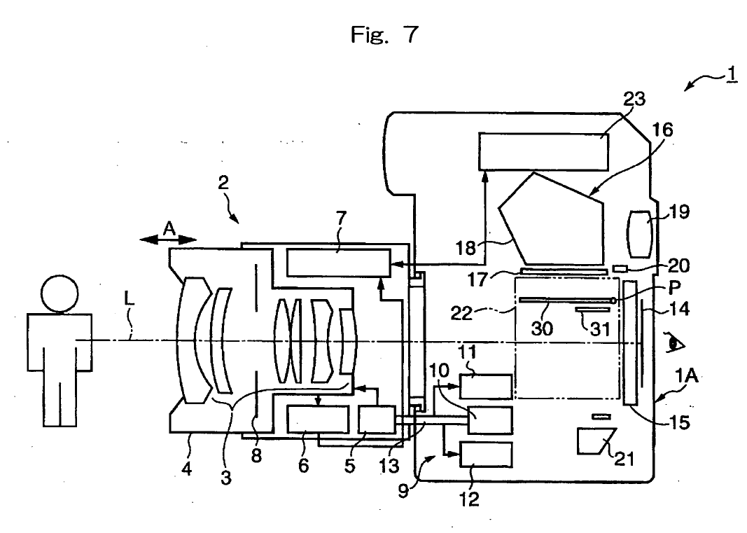

Returning to FIG. 1, the mirror box 22 has a quick-return mirror 30 and a sub mirror 31. The quick-return mirror 30 is structured so as to be rotatable between a position where the mirror 30 is inclined substantially 45 degrees to the optical axis L of the image capturing optical system 3 about an axis P (hereinafter, referred to as inclined position) and a position where the mirror 30 is substantially parallel to the bottom surface of the body 1A as shown in FIG. 7 (hereinafter, referred to as horizontal position).

The sub mirror 31 is disposed on the rear surface side (on the image sensor 14 side) of the quick-return mirror 30. The sub mirror 31 is structured so that its position can be changed, in synchronism with the quick-return mirror 31, between a position where the mirror 31 is inclined substantially 90 degrees to the quick-return mirror 30 in the inclined position (hereinafter, referred to as inclined position) and a position where the mirror 31 is substantially parallel to the quick-return mirror 30 in the horizontal position (hereinafter, referred to as horizontal position). The quick-return mirror 30 and the sub mirror 31 are driven by a mirror driving mechanism 55 described later.

When the quick-return mirror 30 and the sub mirror 31 are in the inclined position, the quick-return mirror 30 reflects most of the luminous flux by the image capturing optical system 3 toward the focusing screen 17, and transmits the remaining part of the luminous flux. At this time, the sub mirror 31 directs the luminous flux transmitted by the quick-return mirror 30 to the phase difference AF module 21. Therefore, in this case, the display of the subject image by the optical finder 16 and the focus adjustment by the phase difference detection method by the phase difference AF module 21 are enabled. At this time, since no luminous flux is directed to the image sensor 14, the display of the live view image by an LCD (liquid crystal display) 34, described later, to display the image obtained by image capturing by the image sensor 14 is not performed. The focus adjustment by the contrast detection method, described later, using the contrast of the image obtained by image capturing by the image sensor 14 is not performed.

The image sensor 14 is structured so as to perform subject image capturing at predetermined intervals (for example, every 1/30 second) as well as image capturing for generating images for recording. The images formed by the image capturing are successively displayed on the LCD 34. The series of images displayed on the LCD 34 at this time are for displaying the condition of the subject substantially in real time, and the above-mentioned live view image is the series of images. With the display of the live view image, the user can visually recognize the condition of the subject by the LCD 4.

When the quick-return mirror 30 and the sub mirror 31 are in the horizontal position, since the quick-return mirror 30 and the sub mirror 31 are retreated from the optical axis L, substantially all of the luminous flux transmitted by the image capturing optical system 3 is projected onto the image sensor 14. Therefore, in this case, the display of the live view image by the LCD 34 and the focus adjustment by the contrast detection method are enabled. On the other hand, the display of the subject image by the optical finder 16 and the focus adjustment by the phase difference detection method by the phase difference AF module 21 are not performed.

As described above, in the image capturing apparatus 1, the positions of the quick-return mirror 30 and the sub mirror 31 and the focus adjustment method that can be executed have a one-to-one correspondence with each other.

As mentioned above, the image capturing apparatus 1 of the present embodiment has the FFP mode in which an arbitrary subject in the shooting area can be specified as the object to be brought into focus (focus point). When the FFP mode is set, it is necessary to set whether the focus adjustment by the phase difference detection method is performed or the focus adjustment by the contrast detection method is performed according to whether the focus point is situated on the AF frames F1 to F11 or not. In response thereto, the quick-return mirror 30 and the sub mirror 31 are driven between the inclined position and the horizontal position according to whether the focus point is situated on the AF frames F1 to F11 or not.

Next, the external structure of the image capturing apparatus 1 will be described.

As shown in FIGS. 2 and 3, the image capturing apparatus 1 is provided with: the lens unit 2 attached substantially in the center of the front surface of the body 1A; a first mode setting dial 32 disposed in an appropriate position of the top surface; a shutter button 33 disposed on an upper side part; the LCD 34 disposed on the left side of the rear surface; setting buttons 35 disposed below the LCD 34; a jog dial 36 disposed on a side of the LCD 34; a push button 37 disposed inside the jog dial 36; the optical finder 16 disposed above the LCD 34; a main switch 38 disposed on a side of the optical finder 16; a second mode setting dial 39 disposed in the proximity of the main switch 38; a connection terminal portion 40 disposed above the optical finder 16; and an AF auxiliary light emitting portion 41 disposed in an appropriate position of the front surface.

The lens unit 2 corresponds to a lens unit 3 shown in FIG. 1. The lens unit 2 can be detached from the body 1A by depressing a release button 42 shown in FIG. 2.

The first mode setting dial 32, which is a substantially disk-shaped member rotatable within a plane substantially parallel to the top surface of the image capturing apparatus 1, is provided for alternatively selecting functions and modes provided to the image capturing apparatus 1 such as a shooting mode to take still images and moving images and a playback mode to play back recorded images. Although not shown, on the top surface of the first mode setting dial 32, characters representative of the functions are printed at predetermined intervals along its circumference. With this, the function corresponding to the character set at the position opposed to an indicator provided in an appropriate position of the body 1A is executed.

The shutter button 33 is a button depressed in two steps of half depression to depress the button 33 halfway and full depression to depress the button 33 all the way. The processings performed by the half depression and full depression of the shutter button 33 will be described when various modes provided to the image capturing apparatus 1 are described because these processings are different among the modes. The half depression of the shutter button 33 is detected by a non-illustrated switch S1 being turned on, and the full depression of the shutter button 33 is detected by a non-illustrated switch S2 being turned on.

On the LCD 34 which comprises a color liquid crystal panel, the live view image is displayed, recorded images are played back, and the screen to set the functions and modes provided to the image capturing apparatus 1 is displayed. Instead of the LCD 34, an organic electroluminescent (EL) display or a plasma display may be used.

The setting buttons 35 are buttons for performing operations for various functions provided to the image capturing apparatus 1, and include a button for switching between display and non-display of the live view image on the LCD 34.

The jog dial 36 has an annular member having depression portions 36a to 36h disposed at predetermined intervals in the circumferential direction, and the depression of the depression portions 36a to 36h is detected by non-illustrated contacts (switches) provided so as to correspond to the depression portions 36a to 36h. The jog dial 36 is provided for inputting instructions to change the shooting magnification (movement of the zoom lens system 19 in the wide-angle or telephoto direction), to advance frame by frame the recorded images played back on the LCD 34 and to set the shooting conditions (the aperture value, the shutter speed, the presence or absence of flash emission, etc.).

To the jog dial 36 of the image capturing apparatus 1 of the present embodiment, the following function is added with the provision of the FFP mode:

In FIG. 4, a plurality of AF frames F1 to F11 representative of areas where the focus adjustment by the phase difference detection method can be performed is displayed on the display screen within the finder frame 16a of the optical finder 16, and the jog dial 36 has the function of selecting the AF frame specified as the focus point from among the AF frames F1 to F11.

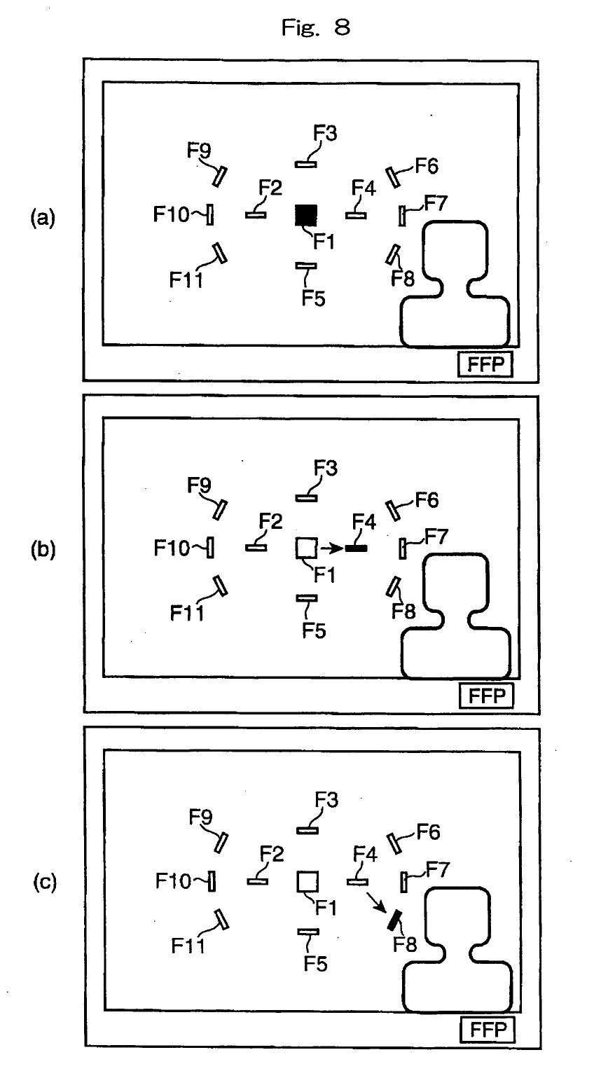

For example, as shown in FIGS. 8(a) to 8(c), when the FFP mode is set, a plurality of AF frames F1 to F11 is displayed on the display screen of the optical finder 16, and immediately after the FFP mode is set, the AF frame F1 situated in the center is initially set as the focus point. The AF frame specified as the focus point is displayed in a different display condition from the other AF frames by a non-illustrated LED lighting up or the like. FIG. 8(a) shows that the AF frame F1 is specified as the focus point. (including at the time of the initial setting).

Then, by depressing, for example, the depression portion 36c of the jog dial 36 from the condition shown in FIG. 8(a), the AF frame F4 situated on the right side of the central AF frame F1 lights up as shown in FIG. 8(b). On the other hand, the central AF frame F1 is turned off, and the AF frame specified as the focus point shifts from the central AF frame F1 to the AF frame F4. Moreover, by depressing, for example, the depression portion 36d of the jog dial 36, the AF frame F8 situated below the AF frame F4 right lights up as shown in FIG. 8(c). On the other hand, the AF frame F4 is turned off, and the AF frame specified as the focus point shifts from the AF frame F4 to the AF frame F8.

Further, in the present embodiment, when the jog dial 36 is depressed so that the specified position shifts further outward from the condition where, of the plurality of AF frames F1 to F11, an AF frame situated at the end (F3, F5 to F11) is specified as the focus point, since the focus adjustment by the phase difference detection method cannot be performed, the mode is changed to the mode to perform the focus adjustment by the contrast detection method.

That is, when, for example, the depression portion 36d of the jog dial 36 is further operated from the condition shown in FIG. 8(c), since the focus adjustment by the contrast detection method is performed, the quick-return mirror 30 and the sub mirror 31 are driven to the horizontal position. Consequently, the subject image is not directed to the optical finder 16, so that the subject image cannot be visually recognized on the display screen of the optical finder 16.

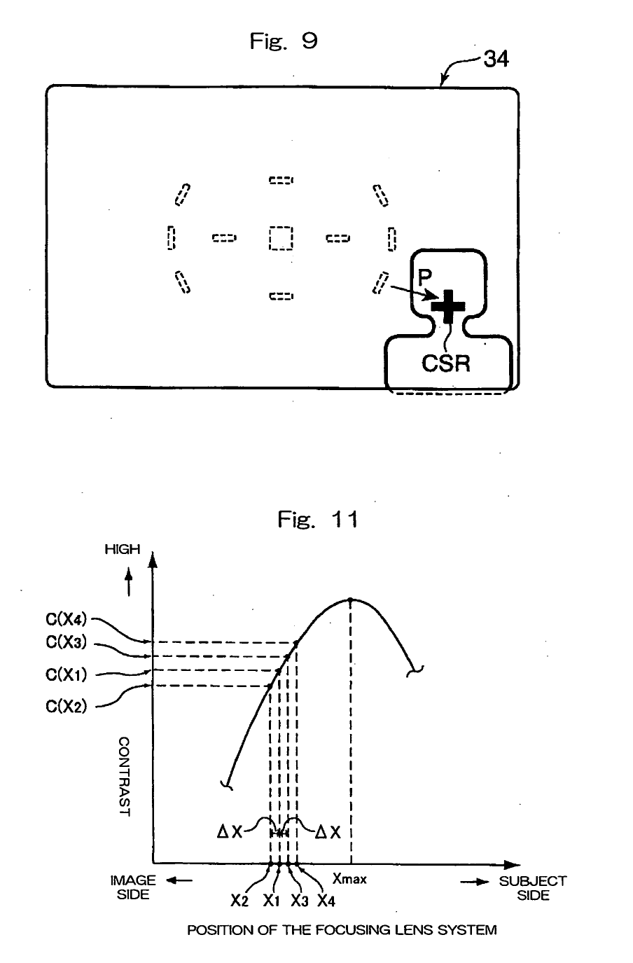

On the other hand, the subject image transmitted by the image capturing optical system 3 is directed to the image sensor 14 as shown in FIG. 9, and the image of the subject obtained by image capturing by the image sensor 14 is displayed on the LCD 34. Further, a cursor CSR is displayed so as to be superimposed on the displayed image as described later. The jog dial 36 has the function of changing the position of the cursor CSR. When the depression portion 36d of the jog dial 36 is depressed, the display position of the cursor CSR shifts in the direction of the arrow P by the movement amount corresponding to the depression time. As described above, the jog dial 36 has the functions of selecting the AF frame specified as the focus point and changing the position of the cursor CSR. To show the relationship between the current position of the cursor CSR and the positions of the AF frames F1 to F11, the AF frames F1 to F11 are palely displayed on the display screen of the LCD 34 as shown by the dotted lines in FIG. 9.

Returning to FIGS. 2 and 3, the push button 37 is provided for inputting instructions to set or non-set the FFP mode and to confirm the focus specified position (focus point). By depressing the push button 37 again after the FFP mode is set by depressing the push button 37, an instruction to confirm the focus point is inputted.

The optical finder 16, which corresponds to the optical finder 16 shown in FIG. 1, optically displays the area where the subject is shot.

The main switch 38 comprises a two-position slide switch that slides laterally. When the main switch 38 is set on the left side, the power of the image capturing apparatus 1 is turned on, and when it is set on the right side, the power is turned off. The second mode setting dial 39 which has a mechanical structure similar to the first mode setting dial 32 is provided for performing operations for various functions provided to the image capturing apparatus 1. The connection terminal portion 40 is a terminal for connecting a non-illustrated external apparatus such as a flash to the image capturing apparatus 1. The AF auxiliary light emitting portion 41 which comprises a light emitting device such as an LED outputs auxiliary light when focus adjustment is performed in a case where the brightness and contrast of the subject are low.

Next, the block structure of the image capturing apparatus 1 will be described with reference to FIG. 10. The same members as those of FIGS. 1 to 9 are denoted by the same reference numerals.

The image capturing optical system 3, which corresponds to the image capturing optical system 3 shown in FIG. 1, is provided with the zoom lens system 43 for changing the shooting magnification (focal length) and the focusing lens system 44 for adjusting the focus position. The AF actuator 10, the output axis 13 and the lens driving mechanism 5 correspond to the AF actuator 10, the output axis 13 and the lens driving mechanism 5 shown in FIG. 1, respectively. A lens position detector 63 includes the distance encoders 6 and 11 and the AF encoder 12 shown in FIG. 1. The lens controller 7 corresponds to the lens controller 7.shown in FIG. 1. A mirror unit 45 includes the quick-return mirror 30 and the sub mirror 31.

The image sensor 14 corresponds to the image sensor 14 shown in FIG. 1. Image capturing operations such as the start and end of the exposure operation by the image sensor 14 and the readout (horizontal synchronization, vertical synchronization, transfer) of the output signals of the pixels at the image sensor 14 are controlled by a timing control circuit 48 described later.

A signal processor 46 performs predetermined analog signal processing on the analog image signals outputted from the image sensor 14. The signal processor 46 is provided with a CDS (correlated double sampling) circuit and an AGC (automatic gain control) circuit. The CDS circuit reduces the noise of the image signals. The AGC circuit adjusts the level of the image signals.

An A/D converter 47 converts the analog image signals of R, G and B outputted from the signal processor 46 into digital image signals of a plurality of bits (for example, 10 bits) based on a clock CLK2 outputted from the subsequently-described timing control circuit 48.

The timing control circuit 48 generates clocks CLK1 and CLK2 based on a reference clock CLK0 outputted from the main controller 23 described later. The timing control circuit 48 outputs the clock CLK1 to the image sensor 14 and outputs the clock CLK2 to the A/D converter 47 to thereby control the operation of the image sensor 14 and the A/D converter 47.

An image processor 49 is provided with a black level correction circuit 50, a white balance circuit (shown as WB circuit in FIG. 10) 51 and a gamma correction circuit 52. The black level correction circuit 50 corrects the black levels of the digital signals of R, G and B A/D converted by the A/D converter 47 to a reference black level. The white balance circuit 51 performs level conversion of the digital signals of color components of R (red), G (green) and B (blue) based on the reference white corresponding to the light source. The gamma correction circuit 52 corrects the gamma characteristics of the digital signals of R (red), G (green) and B (blue).

An image memory 53 temporarily stores the image data outputted from the image processor 49 in the shooting mode, and is used as the work area for performing processing described later on the image data by the main controller 23. In the playback mode, the image memory 53 temporarily stores the image data read out from an image storage 56 described later.

A VRAM 54, which has a storage capacity of image signals corresponding to the number of pixels of the LCD 34, is a buffer memory between the main controller 23 and the LCD 34. The LCD 34 corresponds to the LCD 34 shown in FIG. 2.

The mirror driving mechanism 55 drives the quick-return mirror 30 and the sub mirror 31 between the inclined position and the horizontal position, and is controlled by the main controller 23 (mirror driving controller 59) described later.

The image storage 56 comprises a memory card or a hard disk, and stores images generated by the main controller 23.

An input operation member 57 includes the above-described first mode setting dial 32, shutter button 33, setting buttons 35, jog dial 36, push button 37, main switch 28 and second mode setting dial 39, and inputs operation information to the main controller 23.

The phase difference AF module 21 corresponds to the phase difference AF module 21 shown in FIG. 1.

The main controller 23 comprises a microcomputer incorporating a storage 62 comprising a ROM storing a control program, a flash memory temporarily storing data or the like, and controls the drivings of the members in the image capturing apparatus 1 shown in FIG. 10 so as to be associated with one another. In the present embodiment, the main controller 23 is functionally provided with a mode setting portion 58, the mirror driving controller 59, an AF controller 60 and a display controller 61.

The mode setting portion 58 receives the operation signal of the first mode setting dial 32 to set the shooting mode to perform shooting of the subject or the playback mode to play back the shot image on the LCD 34 or the like. In addition to these functions, the mode setting portion 58 of the present embodiment receives the operation signal of the push button 37 to set the above-described FFP mode in which an arbitrary subject can be brought into focus (the focus point can be specified).

The mirror driving controller 59 controls the operation of the mirror driving mechanism 55 driving the quick-return mirror 30 and the sub mirror 31. The AF controller 60 controls the operation of the AF actuator 10 so that the focusing lens system 44 is situated in the focus position.

The image capturing apparatus 1 of the present embodiment has the function of performing focus adjustment by the phase difference detection method by use of the phase difference AF module and the function of performing focus adjustment by the contrast detection method described later by use of the contrast (a parameter representative of the image clarity) of the image obtained by image capturing by the image sensor 14.

When the focus adjustment by the phase difference detection method is performed, the AF controller 60 sets as the main subject the subject situated in, of the AF frames F1 to F11, the AF frame F1 situated in the center by use of the in-focus data obtained from the phase difference AF module 21. This is because it is considered that the main subject is frequently situated in the center. The subject situated closest to the image capturing apparatus 1 may be set as the main subject. When a plurality of subjects is present at the same distance from the image capturing apparatus 1, a subject closer to the center of the image capturing area may be set as the main subject.

In the image capturing apparatus 1 of the present embodiment, since the FFP mode in which the focus position can be specified is provided, when any of the AF frames F1 to F11 is specified as the focus point in the FFP mode, the subject corresponding to the AF frame specified as the focus point is set as the main subject, and the other subjects are set as sub subjects.

When focus adjustment is performed by the contrast detection method, the AF controller 60 performs the following processing: FIG. 11, which is an explanatory view of the focus adjustment by the contrast detection method, shows the relationship between the position of the focusing lens system 44 in the direction of the optical axis L and the contrast of the image obtained by image capturing by the image sensor 14.

As shown in FIG. 11, with respect to the waveform of the contrast for the position of the focusing lens system 44, generally, when the focusing lens system 44 is situated in a certain lens position, the contrast is highest, that is, the shot image is sharpest. The waveform has a shape like that of a mountain viewed from a side where the contrast decreases as the focusing lens system 44 moves from the lens position toward the image side and the subject side in the direction of the optical axis L. FIG. 11 shows that in a case where a certain subject is shot by the image capturing apparatus 1, contrast is highest when the focusing lens system 44 is situated in a lens position Xₘₐₓ.

The AF controller 60 divides all the area or a partial area of the A/D converted image into very small zones, detects the brightness of each zone, and detects the difference in brightness between the adjoining zones, that is, contrast. The position where contrast is highest is found out by performing this processing for each shot image while moving the focusing lens system 44 in the direction of the optical axis L, and the focusing lens system 44 is situated in the position.

That is, assuming that the focusing lens system 44 is situated in a position X₁ (hereinafter, referred to as reference position X₁) in the direction of the optical axis immediately after the power of the image capturing apparatus 1 is turned on in FIG. 11, when the shutter button 33 is half depressed, the AF controller 60 causes the image sensor 14 to capture the subject image with the focusing lens system 44 being situated in the position X₁, and derives the contrast C(X₁) from the image data. Then, the AF controller 60 moves the focusing lens system 44 by a predetermined movement pitch Δx, for example, toward the image side in the direction of the optical axis L, causes the image sensor 14 to capture the subject image with the focusing lens system 44 being situated in a position X₂ to which the focusing lens system 44 is moved, and derives the contrast C(X₂) from the image data. At this time, since C(X₁)>C(X₂) as is apparent from FIG. 11, the AF controller 60 determines that contrast does not increases even if the focusing lens system 44 is moved from the position X₁ toward the image side, and moves the focusing lens system 44 by a movement amount 2Δx from the position X₂ toward the subject side (subject side by the movement pitch Δx from the reference position X₁).

Then, the AF controller 60 causes the image sensor 14 to capture the subject image with the focusing lens system 44 being situated in a position X₃ to which the focusing lens system 44 is moved, and derives the contrast C(X₃) from the image data. At this time, since the relationship between the heights of the contrasts C(X₁) and C(X₃) in the positions X₁ and X₃ is C(X₁)<C(X₃) as is apparent from FIG. 11, the AF controller 60 determines that contrast increases when the focusing lens system 44 is moved from the position X₁ toward the subject side, and further moves the focusing lens system 44 by the movement pitch Δx from the position X₃ toward the subject side.

Then, the AF controller 60 causes the image sensor 14 to capture the subject image with the focusing lens system 44 being situated in a position X₄ to which the focusing lens system 44 is moved, and derives the contrast C(X₄) from the image data. At this time, since the relationship between the heights of the contrasts C(X₃) and C(X₄) in the positions X₃ and X₄ is C(X₃)<C(X₄) as is apparent from FIG. 11, the AF controller 60 moves the focusing lens system 44 by the movement pitch Δx from the position X₄ toward the subject side.

Likewise, the AF controller 60 repeats the deriving of the contrast, and makes a comparison between the contrast C(Xₙ) in the position Xₙ derived at the n-th time and the contrast C(Xₙ₊₁) in the position Xₙ₊₁ derived at the (n+1)-th time, and when C(Xₙ₊₁)<C(Xₙ), the AF controller 60 determines that the position Xₙ is the in-focus position and fixes the focusing lens system 44 in the position Xₙ. With this, the focus adjustment processing by the contrast detection method is completed. When C(Xₙ₊₁)=C(Xₙ), determining that the highest value of the contrast is between the position Xₙ and the position Xₙ₊₁, the AF controller 60 situates the focusing lens system 44, for example, at the midpoint between the position Xₙ and the position Xₙ₊₁.

As described above, the image capturing apparatus 1 of the present embodiment having two kinds of focus adjustment functions performs the focus adjustment functions according to the condition associated with the FFP mode.

That is, to realize the FFP mode in the image capturing apparatus 1 of the present embodiment having the quick-return mirror 30 as described above, when a position outside the AF frames F1 to F11 is specified as the focus point in the FFP mode, it is impossible to perform the focus adjustment by the phase difference detection method at the focus point and it is necessary to perform the focus adjustment by the contrast detection method.

According to the focus adjustment by the phase difference detection method, not only focus adjustment can be performed in a shorter time than according to the focus adjustment by the contrast detection method but also even if the subject to be brought into focus is moving (moving subject), the subject can be surely brought into focus. However, according to the focus adjustment by the phase difference detection method, only a part (central part) of the shot image can be the region that can be brought into focus because of problems associated with the structure (for example, increase in the size of the phase difference AF module 21 and suppression of cost increase) as mentioned above. On the other hand, according to the focus adjustment by the contrast detection method, the accuracy of the focus adjustment is higher than according to the focus adjustment by the phase difference detection method, and it is possible to bring any subject in the image capturing area into focus. However, according to the focus adjustment by the contrast detection method, the time required for the focus adjustment is longer than according to the phase difference detection method.

In view of the above points, according to the present embodiment, when the focus point is set on the AF frames F1 to F11 in the FFP mode, the quick-return mirror 30 and the sub mirror 31 are set in the inclined position, and focus adjustment is performed by use of the phase difference AF module 21.

Moreover, when the focus point is set outside the AF frames F1 to F11 in the FFP mode, the quick-return mirror 30 and the sub mirror 31 are set in the horizontal position, and focus adjustment is performed by the contrast detection method.

When the FFP mode is not set, for reasons such that the time interval between the half depression and the full depression of the shutter button 3 is comparatively short in normal image capturing and it is therefore required to quickly perform focus adjustment and that the main subject is frequently situated in the center of the image capturing area and it is therefore considered that the main subject can be brought into focus even by the focus adjustment by the phase difference detection method, focus adjustment is performed by use of the phase difference AF module 21 so that the time required for the focus adjustment operation is reduced.

In accordance therewith, when the FFP mode is not set and when the focus point confirmed by a re-operation of the push button 37 is situated on the AF frames F1 to F11 in the FFP mode, the mirror driving controller 59 and the AF controller 60 set the quick-return mirror 30 and the sub mirror 31 in the inclined position, and perform the focus adjustment by the phase difference detection method by use of the phase difference AF module 21.

Moreover, when the focus point confirmed by an operation of the push button 37 is situated outside the AF frames F1 to F11 in the FFP mode, the mirror driving controller 59 and the AF controller 60 perform focus adjustment by the contrast detection method.

The pixels of the image sensor 14 corresponding to the position of the cursor CSR can be derived from the position information of the cursor CSR, and the correspondence between the image capturing areas of the phase difference AF module 21 corresponding to the AF frames F1 to F11 and the pixels of the image sensor 14 is prestored. Consequently, it can be determined whether the focus point is situated on the AF frames F1 to F11 or not.

Returning to FIG. 10, in the shooting mode, to display the live view image and recorded images stored in the image storage 56, the display controller 61 transfers the data of the images to the VRAM 54. Moreover, in the playback mode, the display controller 61 reads out the image data in an image file stored in the image storage 56, performs predetermined decompression processing on the data, and transfers it to the VRAM 54. With this, the image represented by the read image data is played back on the display screen of the LCD 34.

Moreover, in the FFP mode, the display controller 61 displays, for example, letters “FFP” representing that the FFP mode is set, outside the finder frame 16a of the optical finder 16 as shown in FIG. 4. Moreover, the display controller 61 displays the cross-shaped cursor CSR and the AF frames F1 to F11 so as to be superimposed on the displayed image, and changes the display position of the cursor CSR in response to the operation of the jog dial 36.

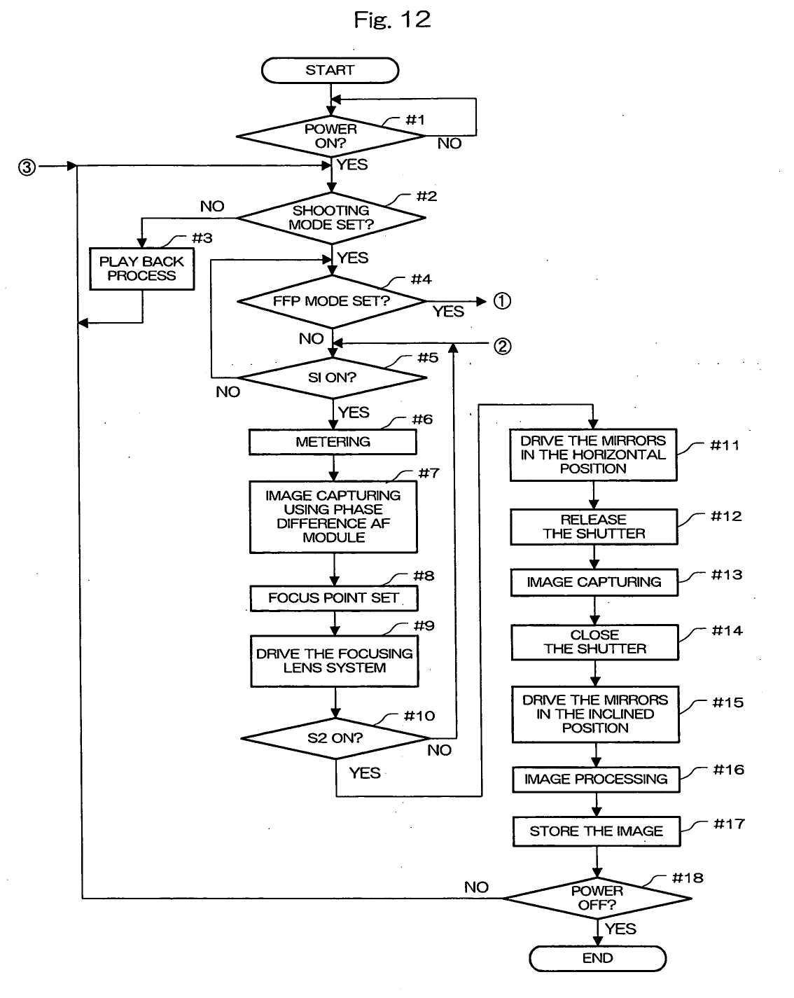

FIGS. 12 to 14 are flowcharts showing a series of processings of the image capturing apparatus 1.

As shown in FIG. 12, when the power of the image capturing apparatus 1 is turned on (YES at step #1), the main controller 23 determines whether the shooting mode is set or not (step #2). When the playback mode is set (NO at step #2), the main controller 23 performs the processing to play back images stored in the image storage 56 on the LCD 34 (step #3). When the shooting mode is set (YES at step #2), the process proceeds to step #4.

At step #4, the AF controller 60 determines whether or not the FFP mode is set by the push button 37 until the shutter button 33 is half depressed (NO at steps #4 and #5). When the shutter button 33 is half depressed (YES at step #5) with the FFP mode not set by the push button 37 (NO at step #4), the main controller 23 performs metering to set the exposure control value (step #6). The metering performed in this processing is performed by a non-illustrated metering unit disposed in the proximity of the prism 18.

Moreover, the AF controller 60 causes the phase difference AF module 21 to perform image capturing (step #7), and sets the focus point (step #8). In this processing, the subject corresponding to, of the AF frames F1 to F11, the AF frame F1 situated in the center is set as the main subject.

Then, the AF controller 60 causes the AF actuator 10 to drive the focusing lens system 44 so that the subject (focus point) set at step #8 is brought into focus (step #9). The main controller 23 repeats the processings at steps #5 to #9 until the shutter button 33 is fully depressed (NO at step #10). When the shutter button 33 is fully depressed (YES at step #10), the mirror driving controller 59 controls the mirror driving mechanism 55 so that the quick-return mirror 30 and the sub mirror 31 are in the horizontal position (step #11). Then, the main controller 23 releases the shutter (step #12), and causes the image sensor 14 to perform image capturing with the exposure control value derived by the metering at step #6 with the focusing lens system 44 being situated in the position set at step #9 (step #13).

Then, the main controller 23 closes the shutter (step #14). The mirror driving controller 59 controls the mirror driving mechanism 55 so that the quick-return mirror 30 and the sub mirror 31 are in the inclined position (step #15). Moreover, the main controller 23 performs image processing such as compression processing on the image obtained by image capturing by the image sensor 14 (step #16), and stores the image-processed image into the image storage 56 (step #17).

Then, the main controller 23 repeats the processings at steps #2 to #17 until the power of the image capturing apparatus 1 is turned off (NO at step #18). When the power is turned off (YES at step #18), the series of processings are ended.

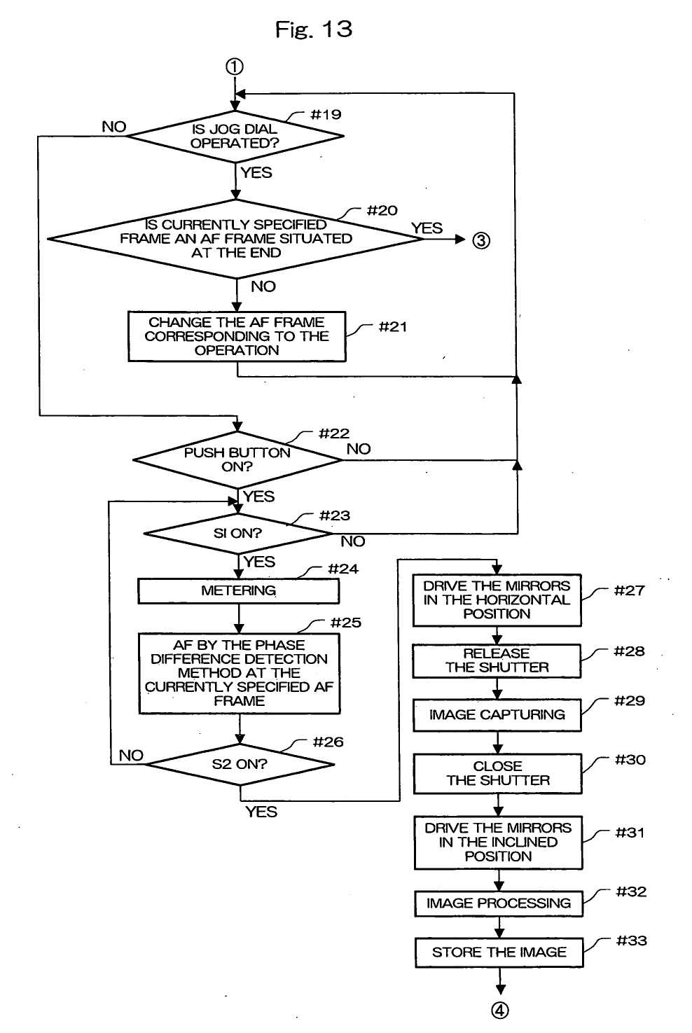

On the other hand, when the FFP mode is set by the push button 37 at step #4 (YES at step #4), as shown in FIG. 13, the main controller 23 determines whether the jog dial 36 is operated or not (step #19). When the jog dial 36 is operated (YES at step S19), it is determined whether the currently specified frame is an AF frame situated at the end (F3, F5 to F11 in FIG. 4) or not (step #20).

When the currently specified AF frame is not an AF frame situated at the end (NO at step #20), the display controller 61 changes the AF frame in the direction corresponding to the operation of the jog dial 36 until the operation on the jog dial 36 is ended or the specified frame is an AF frame situated at the end (step #21).

Then, when the operation on the jog dial 36 is ended (NO at step #19), the main controller 23 determines whether the push button 37 is turned on or not (step #22). When the push button 37 is not turned on (NO at step #22), the process returns to step #19. When the push button 37 is depressed under a condition where any of the AF frames is specified (YES at step #22), the main controller 23 determines whether the shutter button 33 is half depressed or not (step #23). When the shutter button 33 is not half depressed (NO at step #23), the process returns to step #19.

When the shutter button 33 is half depressed (YES at step #23), the main controller 23 determines whether the half depression of the shutter button 33 is released or not (step #23) until the shutter button 33 is fully depressed (NO at step #26). Then, the exposure control value is set by metering (step #24). The AF controller 60 performs the focusing adjustment by the phase difference detection method by use of the image corresponding to the currently specified AF frame (step #25).

Then, when the shutter button 33 is fully depressed (YES at step #26), similar processings to those performed at steps #11 to #17 are performed (steps #27 to #33).

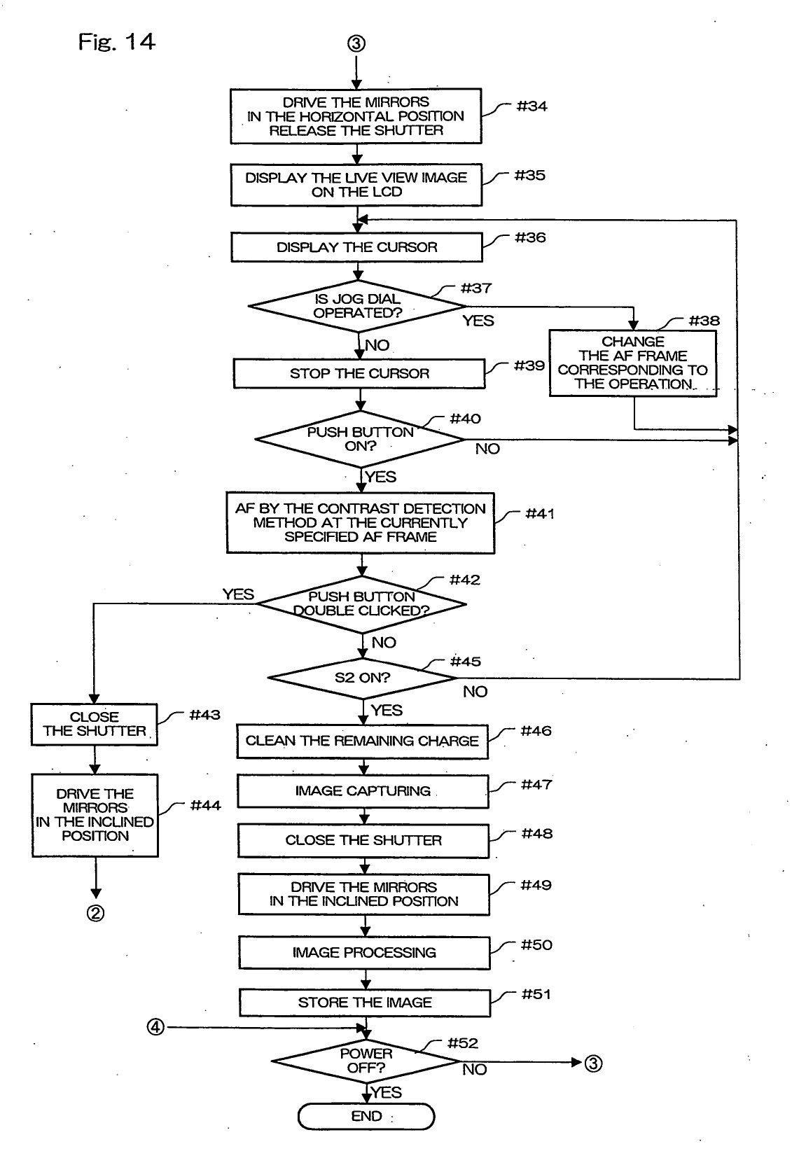

On the other hand, when the currently specified AF frame is an AF frame situated at the end at step #20 (NO at step #20), determining that a position outside the AF frames at the end is specified, the process shifts to step #34 of FIG. 14. As shown in FIG. 14, the mirror driving controller 59 controls the mirror driving mechanism 55 so that the quick-return mirror 30 and the sub mirror 31 are in the horizontal position. Then, the main controller 23 releases the shutter (step #34). In response to the live view image display instruction operation by the user, the display controller 61 displays the live view image on the LCD 34 (step #35), and displays the cursor CSR as shown in FIG. 9 so as to be superimposed on the live view image (step #36).

Then, the main controller 23 determines whether the jog dial 36 is operated or not (step #27). When the jog dial 36 is operated (YES step #37), the display controller 61 changes the display position of the cursor CSR in the direction corresponding to the operation (step #38). When the operation of the jog dial 36 is stopped (NO at step #37), the display controller 61 stops the change of the cursor CSR (step #39).

Then, the main controller 23 determines whether the push button 37 is depressed or not (step #40), and repeats the processings at steps #36 to #39 until the push button 37 is depressed (NO at step #40). When the push button 37 is depressed (YES at step #40), the focus adjustment by the contrast detection method is performed by use of the image of the subject corresponding to the position of the cursor CSR set at step #39 (step #41). Even if an AF frame is again specified by depressing the jog dial 36 after the process shifts to the focus adjustment by the contrast detection method, the focus adjustment by the contrast detection method is continued until the push button 37 is double-clicked at step #42 described later and the FFP mode is canceled.

Then, when the push button 37 is depressed twice (double-clicked) in a short time (YES at step #42) by the time when the shutter button 33 is fully depressed (NO at step #45), the main controller 23 closes the shutter (step #43). Then, the mirror driving controller 59 controls the mirror driving mechanism 55 so that the quick-return mirror 30 and the sub mirror 31 are in the inclined position (step #44), the process returns to step #5. As described above, even if the mode to perform the focus adjustment by the contrast detection method is set, the process can be returned to the focus adjustment by the phase difference detection method by double-clicking the push button 37. Consequently, it is possible to respond to the user's intension with flexibility. The main controller 23 and other members repeat the processings at steps #36 to #42 until the shutter button 33 is fully depressed (NO at step #45).

On the other hand, when the shutter button 33 is fully depressed (YES at step #45) without the push button 37 being double-clicked (NO at step #42), the main controller 23 cleans the charges (pixel signals) remaining at the pixels (step #46), and then, performs similar processings to those performed at steps #13 to #17 (steps #47 to #51).

Then, the main controller 23 repeats the processings at steps #2 to #51 until the power of the image capturing apparatus 1 is turned off (NO at step #52). When the power is turned off (YES at step #52), the series of processings are ended.

As described above, when the FFP mode is set, the quick-return mirror 30 and the sub mirror 31 are driven between the inclined position and the horizontal position according to whether the focus point is in the image capturing area (the AF frames F1 to F11) of the phase difference AF module 21 or not. That is, when the focus point is set within the image capturing area (any of the AF frames F1 to F11) of the phase difference AF module 21, the focus adjustment by the phase difference detection method using the phase difference AF module 21 is performed. When the focus point is set outside the image capturing area of the phase difference AF module 21, focus adjustment is performed by the contrast detection method with the entire image capturing area as the object area of the focus adjustment. Consequently, the FFP mode can be surely executed in the image capturing apparatus 1 having the quick-return mirror 30 and the like like the present embodiment.

Moreover, according to the present embodiment, since the focus adjustment by the phase difference detection method using the phase difference AF module 21 is performed when the focus point is set within the image capturing area (any of the AF frames F1 to F11) of the phase difference AF module 21 and when the FFP mode is not set, focus adjustment can be performed in a short time and even a main subject that is moving can be surely brought into focus (following capability is high compared to the contrast detection method)

Moreover, according to the present embodiment, when the focus point is beyond the image capturing area (the AF frames F1 to F11) of the phase difference AF module 21, even if the focus point is again moved into the image capturing area of the phase difference AF module 21, no switching is made from the focus adjustment by the contrast detection method to the focus adjustment by the phase difference detection method until the FFP mode is canceled (until the push button 37 is double-clicked). With this, when the specified focus point is moved into and out of the image capturing area of the phase difference AF module 21 in a case where the image capturing apparatus 1 is structured so that switching between the focus adjustments by the two methods is made according to whether the focus point is within or outside the image capturing area of the phase difference AF module 21, the quick-return mirror 30 and the like can be prevented from being frequently rotated, so that the operability of the image capturing apparatus 1 can be prevented from being degraded and the user can be prevented from feeling that something is wrong when operating the apparatus.

In addition to or instead of the above-described first embodiment, the present invention can adopt the modifications described in the following (1) to (6):

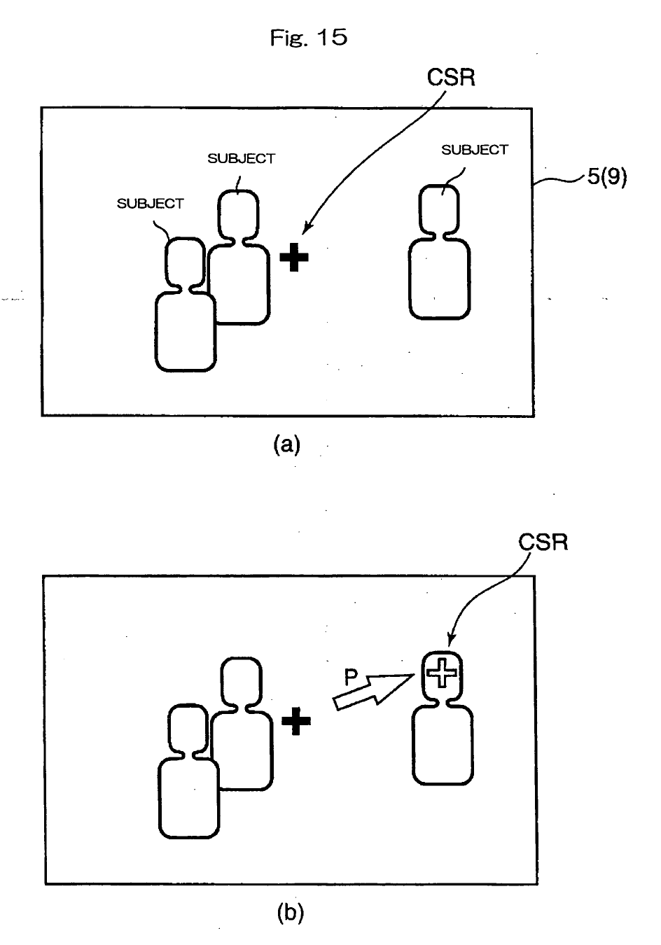

(1) The image capturing apparatus 1 may be structured so that a switching button that switches between display and non-display of the live view image on the LCD 34 irrespective of whether the FFP mode is set by the push button 37 or not is provided among the setting buttons 35 and the FFP mode is automatically set when an instruction to provide the live view display is provided by the switching button. In this case, when an instruction to provide the live view display is provided by the switching button, the processings at step #34 and succeeding steps of FIG. 14 are performed. Moreover, the image capturing apparatus 1 may be structured so that when the cursor CSR is displayed on the display screen of the LCD 34 at step #36, with the initial display position of the cursor CSR being the center of the display screen as shown in FIG. 15(a), the cursor CSR can be moved from the central position as shown in FIG. 15(b).

With this, the operation to input an instruction to display the live view image on the LCD 34 can be double as the operation to set the FFP mode, so that the operability of the image capturing apparatus 1 can be improved.

(2) In the first embodiment, when the specified position of the focus point is outside the AF frames F1 to F11 in the FFP mode, focus adjustment is performed by the contrast detection method. However, the image capturing apparatus 1 may be structured so that when it is considered that highest priority should be given to bringing the specified focus point into focus in the FFP mode, focus adjustment is always performed by the contrast detection method in the FFP mode irrespective of whether the specified position of the focus point is within or outside the AF frames F1 to F11.

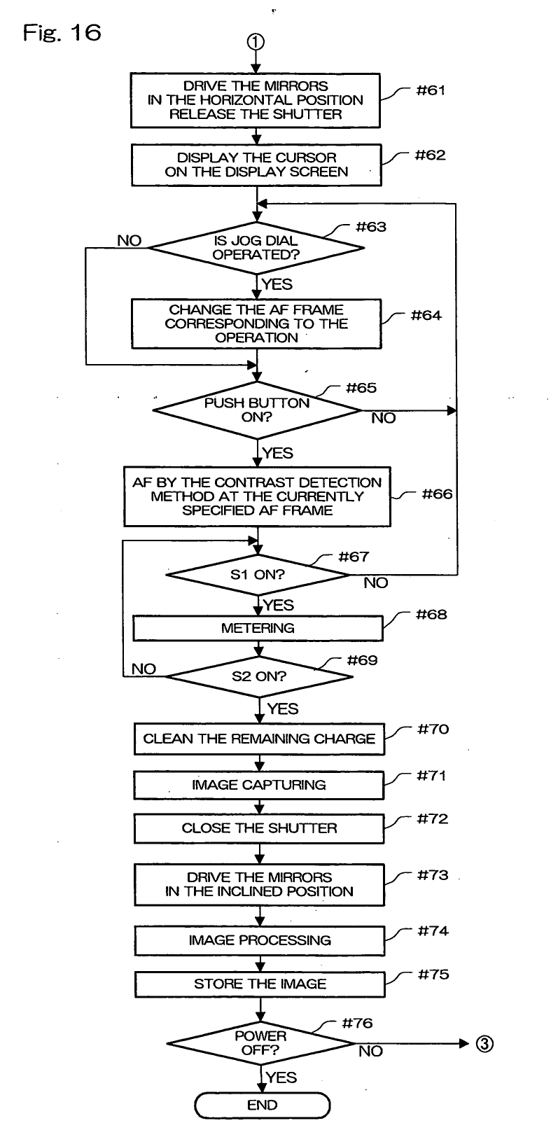

FIG. 16 is a flowchart showing a series of processings in the image capturing apparatus 1 according to the present embodiment. In the present embodiment, although the processings at steps #1 to #18 in FIG. 12 are performed like in the first embodiment, since the processings performed when the FFP mode is set are different from those in the first embodiment, only the processings different from those of the first embodiment are shown in FIG. 16 and will be described.

As shown in FIG. 16, when the FFP mode is set by the push button 37 (YES at step #4, see FIG. 12), the mirror driving controller 59 controls the mirror driving mechanism 55 so that the quick-return mirror 30 and the sub mirror 31 are in the horizontal position. Then, the main controller 23 releases the shutter (step #61). The display controller 61 displays the cursor CSR on the display screen of the LCD 34 so as to be superimposed on the live view image (step #62).

When the jog dial 36 is not operated (NO at step #63), the display controller 61 displays the cursor CSR in a predetermined position. When the jog dial 36 is operated (YES at step #63), the display controller 61 changes the display position of the cursor CSR in the direction corresponding to the operation (step #64). The main controller 23 repeats the processings at steps #63 and #64 until the push button 37 is again depressed (NO at step #65). When the push button 37 is again depressed (YES at step #65), the AF controller 60 performs the focus adjustment by the contrast detection method by use of the image of the subject corresponding to the position of the cursor CSR set at step #62 or #64 (step #66).

Then, the AF controller 60 repeats the processings from steps #63 to #66 until the shutter button 33 is half depressed (NO at step #67). Then, when the shutter button 33 is half depressed (YES at step #67), the main controller 23 causes the metering unit 9 to perform metering (step #68) until the shutter button 33 is fully depressed (NO at step #69). The metering at this time is performed based on the image signal of the image sensor 14.

Then, when the shutter button 33 is fully depressed (YES at step #69), the main controller 23 cleans the remaining charges at the pixels (step #70), and then, performs similar processings to those performed at steps #13 to #17 shown in FIG. 12 (steps #47 to #75).

Then, the main controller 23 and other members repeat the processings at steps #2 to #18 and #61 to #75 until the power of the image capturing apparatus 1 is turned off (NO at step #76). When the power is turned off (YES at step #76), the series of processings are ended.

(3) While according to the contrast detection method, the position of the focusing lens system 44 is determined based on the contrast of the image, the present invention is not limited thereto. The position of the focusing lens system 44 may be determined based on the spatial frequency of the image.

(4) The operation member for changing the display position of the cursor CSR is not limited to one of the above-described structure having the depression portions 36a to 36h and the contacts provided so as to correspond thereto. For example, it may be one of a structure having a lever capable of swinging 360 degrees about a certain point and a detector detecting the direction of inclination of the lever.

(5) Instead of the optical finder 16, an electronic view finder may be used that comprises a non-illustrated color liquid crystal panel and eyepiece and displays the subject image on the color liquid crystal panel by use of a luminous flux transmitted by the image capturing optical system and separated and directed by non-illustrated separating means and light directing means.

(6) For example, a button (operation member) for alternatively switching between the focus adjustment by the phase difference detection method and the focus adjustment by the contrast detection method may be provided among the setting buttons 35. By providing such an operation member, the focus adjustment by the contrast detection method can be set by the operation member even in a case where the image capturing apparatus 1 is structured so that the focus adjustment by the phase difference detection method is automatically performed when the focus point is situated within the image capturing area (the AF frames F1 to F11) of the phase difference AF module 21 like the first embodiment. With this, higher priority can be given to the accuracy of the focus adjustment than to the speed (temporal speed) of the focus adjustment.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being including therein.

1. An image capturing apparatus comprising:
an image sensor for photoelectrically converting a light image of a subject;
an image capturing optical system including a focusing lens for forming a subject image on an image sensing surface of the image sensor;
a first detector for detecting a focus condition of the focusing lens by a phase difference detection method;
a second detector for detecting a focus condition of the focusing lens based on an image obtained by the image sensor;
a mode selector for switching between a first mode in which input to specify a position within an image capturing area of the image sensor as a focus point is possible and a second mode in which focus adjustment is performed with the focus point automatically selected;
an operation member for performing input to specify the focus point in the first mode; and
a focus controller for performing a first control to perform focusing of the focusing lens based on a result of the detection by the first detector and a second control to perform focusing of the focusing lens based on a result of the detection by the second detector, and for switching between the first control and the second control when the first mode is set.

2. An image capturing apparatus as claimed in claim 1, wherein the focus controller switches between the first control and the second control according to a position specified as the focus point by the operation member.

3. An image capturing apparatus as claimed in claim 2, wherein the focus controller performs the second control when a position specified as focus point by the operation member is outside a focus detection area of the first detector.

4. An image capturing apparatus as claimed in claim 1, wherein after switching is made from the first control to the second control, the focus controller inhibits switching from the second control to the first control until the first mode is canceled.

5. An image capturing apparatus as claimed in claim 1, further comprises an optical path changing optical system whose position is changeable between a first position in which a light image from the image capturing optical system is directed to the first detector and a second position in which a light image from the image capturing optical system is directed to the image sensor, and
wherein, when the second mode is set, the optical path changing optical system is set in the first position, and the focus controller performs the first control.

6. An image capturing apparatus as claimed in claim 5, further comprising:
a first display for displaying a light image directed from the image capturing optical system when the optical path changing optical system is in the first position; and
a second display for displaying an image obtained by the image sensor.

7. An image capturing apparatus as claimed in claim 6, wherein the first and second display display the focus point to be specified when the first mode is set.

8. An image capturing apparatus as claimed in claim 5, wherein the optical path changing optical system consists of a quick-return mirror and a sub mirror.

9. An image capturing apparatus as claimed in claim 1, wherein the first detector has a plurality of focus detecting sensors for capturing a light image directed from the image capturing optical system, and detects a focus position of the focusing lens based on outputs from the plurality of focus detecting sensors.

10. An image capturing apparatus as claimed in claim 1, wherein the second detector detects the focus condition of the focusing lens based on a contrast of the image obtained by the image sensor.

11. An image capturing apparatus comprising:
an image sensor for photoelectrically converting a light image of a subject;
an image capturing optical system including a focusing lens for forming a subject image on an image sensing surface of the image sensor;
a mode selector for switching between a first mode in which input to specify a position within an image capturing area of the image sensor as a focus point is possible and a second mode in which focus adjustment is performed with the focus point automatically selected;
an operation member for performing input to specify the focus point in the first mode;
an optical path changing optical system whose position is changeable between a first position, in an optical path from the image capturing optical system to the image sensor, and a second position, withdraw from the optical path;
a driver for driving the optical path changing optical system in the second position when the first mode is set;
a first detector for detecting a focus condition of the focusing lens based on an image obtained by the image sensor in a predetermined area corresponding to a position specified as the focus point by the operation member when the first mode is set; and
a focus controller for causing the focusing lens to perform focusing based on a result of the detection by the first detector.

12. An image capturing apparatus as claimed in claim 11, further comprises a second detector having a plurality of focus detecting sensors for capturing a light image directed from the image capturing optical system, for detecting a focus position of the focusing lens based on outputs from the plurality of focus detecting sensors by a phase difference detection method, and
wherein when the second mode is set, the driver drives the optical path changing optical system in the first position, and
wherein the focus controller performs focusing of the focusing lens based on the result of the detection by the second detector.

13. An image capturing apparatus as claimed in claim 11, wherein the optical path changing optical system consists of a quick-return mirror and a sub mirror.

14. An image capturing apparatus as claimed in claim 11, wherein the first detector detects the focus condition of the focusing lens based on a contrast of the image obtained by the image sensor.

15. An image capturing apparatus comprising:
an image sensor for photoelectrically converting a light image of a subject;
an image capturing optical system including a focusing lens for forming a subject image on an image sensing surface of the image sensor;
a focus controller for causing the focusing lens to perform focusing;
an optical path changing optical system whose position is changeable between a first position, in an optical path from the image capturing optical system to the image sensor, and a second position, withdraw from the optical path;
a display for displaying an image obtained by the image sensor;
a driver for driving the optical path changing optical system between the first position and the second position;
a first mode selector for switching between a first mode in which input to specify a position in an image capturing area of the image sensor as a focus point is possible and a second mode in which focus adjustment is performed with the focus point automatically selected;
an operation member for performing input to specify the focus point in the first mode; and
a second mode selector for selecting a display mode to display the image of the subject on the display,
wherein when the display mode is set by the second mode selector, the first mode selector sets the first mode.

16. An image capturing apparatus as claimed in claim 15, wherein when the display mode is set by the second mode selector, the driver drives the optical path changing optical system in the second position, and the focus controller performs focusing of the focusing lens so that a subject corresponding to a position specified as a focus point by the operation member is brought into focus.

17. An image capturing apparatus as claimed in claim 15, further comprises a finder for displaying a light image directed from the image capturing optical system when the optical path changing optical system is in the first position;

18. An image capturing apparatus as claimed in claim 15, further comprises an indicator for indicating that the first mode is set.

19. An image capturing apparatus as claimed in claim 15, wherein the optical path changing optical system consists of a quick-return mirror and a sub mirror.

20. A method of a focus adjustment of an image capturing apparatus having a focusing lens, comprising the steps of:
photoelectrically converting a light image of a subject by an image sensor;
selecting a mode in which input to specify a position within an image capturing area of the image sensor as a focus point is possible;
performing input to specify the focus point in the mode;
when the specified focus point is a first area, performing the focus adjustment of the focusing lens based on a result of the detection by a first detector which detects a focus condition of the focusing lens by a phase difference detection method; and
when the specified focus point is a second area, performing the focus adjustment of the focusing lens based on a result of the detection by a second detector which detects a focus condition of the focusing lens based on an image obtained by the image sensor.

21. A method of a focus adjustment of an image capturing apparatus having a focusing lens, comprising the steps of:
photoelectrically converting a light image of a subject by an image sensor;
selecting a mode in which input to specify a position within an image capturing area of the image sensor as a focus point is possible;
automatically selecting a focus mode in which detects a focus condition of the focusing lens based on an image obtained by the image sensor, in response to the selection of the focus point specify mode;
performing input to specify the focus point;
detecting a focus condition of the focusing lens based on an image obtained by the image sensor in a predetermined area corresponding to the specified focus point; and
performing the focus adjustment of the focusing lens based on the detected focus condition.

22. A method of a focus adjustment of an image capturing apparatus having a focusing lens, comprising the steps of:
photoelectrically converting a light image of a subject by an image sensor;
selecting a display mode to display the image of the subject on a display;
automatically selecting a focus mode in which input to specify a position in an image capturing area of the image sensor as a focus point is possible, in response to the selection of the display mode;
performing input to specify the focus point in the focus mode; and
performing the focus adjustment of the focusing lens based on a position of the specified focus point.
